(19) United States
(12) Patent Application Publication
(10) Pub. No.: US 2025/0381559 A1
(43) Pub. Date: Dec. 18, 2025

(54) CATALYST FOR LIGHT HYDROCARBON CRACKING TO PRODUCE HYDROGEN AND HIGH VALUE SOLID CARBON

(71) Applicant: Chevron U.S.A. Inc., San Ramon, CA (US)

(72) Inventors: Xiaoying OUYANG, Albany, CA (US); Huping LUO, Moraga, CA (US); Howard Steven LACHEEN, Richmond, CA (US); Christopher Declan LANE, Kensington, CA (US)

(73) Assignee: Chevron U.S.A. Inc., San Ramon, CA (US)

(21) Appl. No.: 19/239,184

(22) Filed: Jun. 16, 2025

Related U.S. Application Data
(60) Provisional application No. 63/661,091, filed on Jun. 18, 2024.

(51) Int. Cl. B01J 37/02; B01J 23/72; B01J 23/755; B01J 37/08; C01B 3/30

(52) U.S. Cl. CPC B01J 37/0213; B01J 23/72; B01J 23/755; B01J 37/0236; B01J 37/088; C01B 3/30

(57) ABSTRACT

A method for preparing a Ni—Cu alloy catalyst is provided in which the catalyst exhibits improved stability as a catalyst for methane cracking to produce hydrogen and solid carbon. In one embodiment, a method of cracking methane is also provided using the Ni—Cu alloy catalyst.

### CROSS REFERENCE TO RELATED APPLICATIONS

The present application claims priority to U.S. Provisional Application No. 63/661,091, filed Jun. 18, 2024, the complete disclosure of which is incorporated herein by reference in its entirety.

### BACKGROUND

Today, individuals and groups are working to identify, build, and implement solutions to accelerate the goal of net zero carbon emission. An area of particular focus in achieving this goal is electrification; however, given the properties of current battery technologies, direct electrification is challenging in industries such as aviation, marine and heavy-duty, long-haul freight. In these areas, where direct, top-to-bottom electrification is not feasible, the use of hydrogen fuel represents an alternate and promising lower carbon solution.

Hydrogen provides clean, emissions free energy when used as a fuel source. However, hydrogen, while it exists atomically in vast numbers, exists scarcely as a gas. Thus, the reliable, economic, and sustainable production of hydrogen gas for use as fuel represents a crucial step in reducing net global carbon emissions. Many current methods of hydrogen production also produce CO₂, such as steam reforming of methane (SMR). These methods require the integration of additional capture carbon and storage (CCS) technology to prevent emissions, increasing operating cost and complexity. Conversely, successful catalytic cracking of light hydrocarbons (e.g., methane, ethane, natural gas, etc.) would allow the production of “blue” hydrogen and solid carbon rather than CO₂, mitigating the need for CCS.

Yet, despite decades of research on catalyst development, a high-performance catalyst for the catalytic cracking of light hydrocarbons remains elusive. The challenges lie primarily in achieving catalyst stability and recyclability, both critical for developing commercially viable catalysts for this process.

Ni—Cu alloy catalysts are known for their ability to catalyze methane decomposition to produce hydrogen and solid carbon. In this formulation, Ni is the active site where the light hydrocarbon decomposition and solid carbon growth occur, whereas Cu is an additive which is not active for light hydrocarbon decomposition but, once forming an alloy with Ni, can decrease the surface reactivity and thus improve the catalyst stability. The preparation method has a significant impact on the degree of alloying. A high degree of alloying is beneficial for improving the catalyst stability. There are publications on the ways to improve the degree of alloying. However, further improvement is still needed.

To provide a novel, efficient, stable, and high-performing catalyst that allows the production of low cost, blue hydrogen would be of great benefit and interest to the industry.

### SUMMARY

Against this backdrop the present invention was developed. A method of producing a Ni—Cu alloy catalyst is provided comprising mixing a chelating agent with nickel precursor solution, and a copper precursor solution to provide a mixture. The mixture is then used to contact a support to impregnate the support with the mixture. In one embodiment, the chelating agent can be selected from malic acid, citric acid, oxalic acid, EDTA, HEDP, or a mixture thereof. In another embodiment, the catalyst support, comprises carbon nanotubes. In one embodiment, the Ni—Cu alloy catalyst is used in a methane cracking reaction, while exhibiting improved stability. Novel Ni—Cu alloy comprising solids are also provided.

Among other factors, it has been discovered that using a chelating agent in the production of Ni—Cu alloy catalysts improves the uniformity of the metal dispersion on the support. This improved uniformity of metal dispersion results in improved catalyst stability. The catalyst is of particular application in methane cracking to produce hydrogen and solid carbon.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWING

The FIGURE graphically depicts Methane Conversion (%) vs. Time (hr.).

### DETAILED DESCRIPTION

Before the method of producing the present Ni—Cu catalyst and its use in methane cracking to produce hydrogen and solid carbon are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present method concerns a modification to the incipient wetness impregnation methods for the production of Ni—Cu alloy catalysts, with a particular focus on the application of these catalysts in light hydrocarbon catalytic cracking, with the objective of producing hydrogen and solid carbon. The present incipient wetness impregnation method follows a protocol involving mixing a chelating agent with a nickel precursor solution and a copper precursor solution either simultaneously or sequentially to prepare a mixture. The nickel precursor solution can be, but is not limited to a nickel salt such as nickel nitrate, nickel sulfate, nickel acetate, nickel acetylacetonate, nickel chloride in an aqueous or organic solvent. The copper solution can be, but is not limited to a copper salt such as copper nitrate, copper sulfate, copper acetate, copper acetylacetonate, copper chloride in an aqueous or organic solvent. The selection of the particular organic solvent is dependent on the solubility of the Ni salt and Cu salt. Common organic solvents that may be used in this preparation are, but not limited to, acetone, toluene, THF, and ethanol. Other suitable organic solvents are well known to one in the industry. Aqueous solutions can also be used.

A characteristic of the solutions containing chelating agents is that the viscosity of metal complex solutions increases significantly due to a gelling process, affecting the drying stage, inhibiting the redistribution of surface species and favoring the formation of poorly crystalized compounds with high dispersion. It has now been discovered that by adding a chelating agent to the impregnation solution at an optimum ratio of Ni and Cu one can improve the uniformity of the metal dispersion on the support, and therefore increase the degree of alloying to improve the catalyst stability during the light hydrocarbon catalytic cracking involved a methane composition.

The term “chelating agent,” as used herein, may be used interchangeably with “ligand”, “ligating agent” or “complexing agent” (or chelator, or chelant), referring to an additive that combines with metal ions, e.g., Group VIB and/or Promoter metals, forming a larger complex, e.g., a catalyst precursor, and facilitating the tuning or adjustment of the porosity of the mesopores.

In one embodiment, the chelating agent is charge neutral or has a negative charge. In another embodiment, the chelating agent is a non-toxic organic oxygen containing compound with an LD50 rate (as single oral dose to rats) of greater than 500 mg/kg. The term “charge neutral” refers to the fact that the catalyst precursor carries no net positive or negative charge. Examples include but are not limited to polydentate as well as monodentate, e.g., NH₃ as well as alkyl and aryl amines; carboxylates, carboxylic acids, aldehydes, ketones, the enolate forms of aldehydes, the enolate forms of ketones and hemiacetals; organic acid addition salts such as formic acid, acetic acid, propionic acid, maleic acid, malic acid, gluconic acid, fumaric acid, succinic acid, tartaric acid, citric acid, oxalic acid, glyoxylic acid, aspartic acid, alkane sulfonic acids, aryl sulfonic acids; arylcarboxylic acids; carboxylate containing compounds; and combinations thereof.

In one embodiment, the chelating agent used in the present method of producing Ni—Cu alloy catalysts can comprise malic acid, citric acid, oxalic acid, EDTA (ethylene diamine tetra acetic acid) and HEDP (etidroniuc acid or 1-hydroxyethylidene diphosphonic acid). In another embodiment, the chelating agent is citric acid.

In producing the Ni—Cu alloy catalyst, the molar ratios of the Ni, Cu, and chelating agent are important. The impregnation solution should have sufficient copper precursor, nickel precursor and chelating agents to ensure a successful metal dispersion on the support. The molar ratio of Ni to Cu in the impregnation solution can range from 1/1 to 100/1 nickel/copper. In one embodiment, the molar ratio of nickel/copper can range from 1/1 to 30/1, and in another embodiment from 1/1 to 10/1. The molar ratio of nickel/chelating agent in the impregnation solution can range from 5/1 to 1/50 nickel/chelating agent. In another embodiment, the molar ratio of nickel/chelating agent can range from 2/1 to 1/20, and in another embodiment, from 1/1 to 1/10.

The particle size of the Ni—Cu alloy particle can vary greatly. Generally, the size is 50 nm or less in diameter. In one embodiment the particle size can range from 5-50 nm, and in another embodiment from 20-30 nm.

Once the mixture has been made, the mixture is brought in contact with a catalyst support to impregnate the support with the mixture. The support can be placed in solution with the mixture and stirred to affect impregnation. Sonication can be used to aid in affecting the impregnation of the support, but sonication is optional. Should sonication be used, it would generally precede stirring of the solution to affect impregnation. The mixture could also be sprayed onto the support to impregnate the support. Simply soaking the support in the mixture can also be effective. Any suitable impregnation method can be used.

The catalyst support used can be any catalytic support known to the industry. Carbon nanotubes are among the preferred supports for the catalyst. Such carbon nanotubes are commercially available, for example, and can be purchased from Cheaptubes.com. The carbon nanotubes can generally have an outside diameter (O.D.) that ranges from 5 to 150 nm. In one embodiment, the O.D. can range from 10-100 nm, or even from 20-50 nm. Other traditional catalyst supports can also be used, such as aluminas, silicas, aluminasilicates, titanates, and metal oxides such as magnesium oxides.

The impregnated catalyst solids are then dried, i.e., any solvent, organic or aqueous, is removed. The drying can be at a suitable temperature and for a length of time needed to ensure the solids are dry and free of solvent. The drying can also take place in stages, or in a single stage of drying. When an organic solvent is used, the drying can take place by allowing the solvent to evaporate at ambient conditions. Additional drying can take place at a temperature of about 100-150° C., in one embodiment around 140° C., for a length of time ranging from 5-9 hours, in one embodiment about 8 hours. Such additional drying is often employed should the copper or nickel precursors have coordinated water.

Further heating of the catalyst to decompose any remaining metal salts can then be conducted. The heating can take place immediately after drying or shortly before use of the catalyst in a methane decomposition reaction, or both. The heating for decomposing any remaining metal salts can generally be accomplished at a temperature that ranges from 150-400° C. In one embodiment, the temperature ranges from 200-300° C. The length and temperature used will depend on the quantity of the metal salts.

Before the catalyst is used in a methane cracking reaction, it is generally reduced/activated by heating at a high temperature in the range of 400 to 700° C. In one embodiment, the temperature is about 600° C. The activation can be conducted in the presence of hydrogen, but this is optional. If hydrogen is used, it can be diluted with an inert gas such as nitrogen. The level of hydrogen, if used, can range from 1 vol. % to 100 vol. %, but is generally in the 5 to 10 vol. % range with the remainder nitrogen or another inert gas.

Due to the high temperature used in the activation/reduction, one can omit the metal salt decomposition step previously discussed, which is generally in the 150 to 400° C. range. The activation/reduction step would decompose any remaining metal salts, leaving only the Ni—Cu alloy.

The catalyst has been found useful in a methane decomposition/cracking reaction which produces hydrogen and solid carbon. The reaction comprises containing a methane composition with a present Ni—Cu alloy catalyst prepared by the present method of preparation. The reaction temperature can generally range from 500° C. to 700° C. In one embodiment, the reaction temperature is about 600° C. The product of the reaction is hydrogen and solid carbon. If carbon nanotubes are used as the support for the catalyst, then the solid carbon product of the reaction can contain carbon nanotubes as part of the product. The present Ni—Cu alloy catalyst shows improved stability with regard to the methane decomposition reaction, as demonstrated in the following examples.

The following examples are provided in order to further illustrate the present method of preparing the present Ni—Cu catalyst, and it stability during methane cracking to produce hydrogen and solid carbon.

### Catalyst Preparation and Testing

### Example 1

The catalyst denoted Catalyst #1 was prepared by mixing a 400 mL acetone solution containing Ni(NiO₃)₂ 6H₂O (7.71 g) and Cu(NO₃)₂ 2.5H₂O (0.521 g) with 13 g of multiwalled carbon nanotubes (20-30 nm, purchased from Cheaptubes.com). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N₂.

The catalyst denoted Catalyst #2 was prepared by mixing a 400 mL acetone solution containing Ni(NiO₃)₂ 6H₂O (7.71 g), Cu(NO₃)₂ 2.5H₂O (0.521 g), and citric acid (3.700 g) with 13 g of multiwalled carbon nanotubes (20-30 nm, purchased from Cheaptubes.com). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N₂.

The catalyst denoted Catalyst #3 was prepared by mixing a 400 mL acetone solution containing Ni(NiO₃)₂ 6H₂O (7.71 g), Cu(NO₃)₂ 2.5H₂O (0.521 g), and citric acid (0.740 g) with 13 g of multiwalled carbon nanotubes (20-30 nm, purchased from Cheaptubes.com). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N₂.

Catalytic test: a fluidized bed quartz reactor was used for a methane catalytic cracking reaction at ambient pressure. The diameter of the reactor was 1″. The reactor was set up in a vertical three-zone heater. As-synthesized catalysts (1.3 g) were loaded on a distributor made from a quartz frit which was in the middle of the reactor so that the fluidized catalyst bed was within the isothermal zone of the heater. N₂ gas was used as an internal standard for product analysis using online GC. Prior to each test, the 1.3 g catalyst samples were reduced in situ at 600° C. under 25 mL/min 5 vol % H₂/Ar overnight. Subsequently, the feed was switched to 52 mL/min 32 vol % CH₄/N₂. The methane conversion was calculated based on the disappearance of methane from the feed.

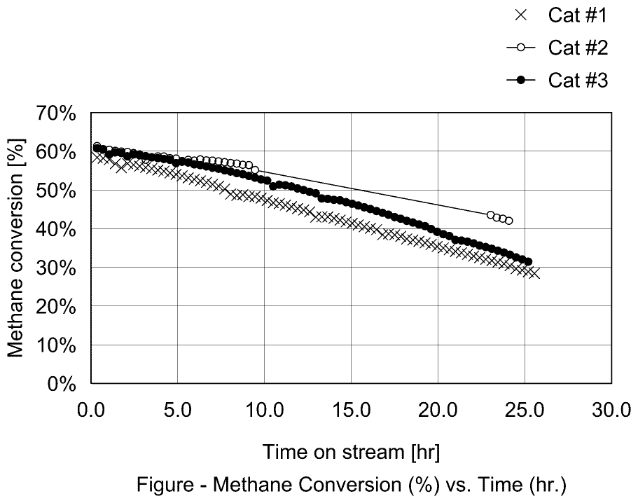

Results of Catalytic Test: FIG. 1 depicts a comparison of the activity and stability (within 25 hours) of the three catalysts described above. The results clearly show that the addition of a chelating agent-citric acid, has significantly higher stability than Catalyst #1 which was free from chelating agent. As shown, Catalyst #3 is more stable than Catalyst #1, but less stable than Catalyst #2, suggesting that a greater amount of chelating agent is likely beneficial.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A method of producing a Ni—Cu alloy catalyst comprising:
mixing a chelating agent with a nickel precursor salt and a copper precursor salt in solution to provide a mixture; and
contacting a support with the mixture to impregnate the support with the mixture.

2. The method of claim 1, wherein the solution of the mixture is an organic based solution or an aqueous solution.

3. The method of claim 2, wherein the solution comprises an organic solvent.

4. The method of claim 3, wherein the organic solvent comprises acetone.

5. The method of claim 1, wherein the contacting of the support with the mixture to impregnate the support with the mixture comprises spraying the support with the mixture, stirring a solution comprising the support and the mixture, or sonicating a solution comprising the support and the mixture.

6. The method of claim 1, wherein solvent is removed from the impregnated support to produce a Ni—Cu alloy catalyst solid comprising the chelating agent.

7. The method of claim 6, wherein the solid is heated to remove coordinated water from the copper and nickel precursors.

8. The method of claim 7, wherein the heating is to a temperature in the range of from 100 to 150° C.

9. The method of claim 7, wherein the heated solid is further heated to a temperature in the range of from 150 to 400° C. for a period of time sufficient to decompose the metal salts and leave the copper and nickel metal oxide on the support.

10. The method of claim 1, wherein the chelating agent is malic acid, citric acid, oxalic acid, EDTA, HEDP, or a mixture thereof.

11. The method of claim 1, wherein the nickel precursor comprises a nickel nitrate and the copper precursor comprises a copper nitrate compound.

12. The method of claim 1, wherein the support comprises carbon nanotubes.

13. The method of claim 12, wherein the carbon nanotubes have an outside diameter that ranges from 1-150 nm.

14. The method of claim 13, wherein the outside diameter ranges from 20-50 nm.

15. The method of claim 9, wherein the heating is conducted in flowing non-reactive gas.

16. The method of claim 15, where the gas comprises N₂.

17. A Ni—Cu catalyst prepared by the method of claim 1.

18. A Ni—Cu alloy solid comprising a support impregnated with a Ni—Cu alloy and a chelating agent.

19. The solid of claim 18, wherein the support comprises carbon nanotubes.

20. The solid of claim 19, wherein the carbon nanotubes have an outside diameter ranging from 5 to 150 nm.

21. The solid of claim 20, wherein the outside diameter ranges from 20 to 50 nm.

22. A process of conducting a methane catalyst cracking reaction comprising cracking methane over a catalyst prepared by the method of claim 1 to produce hydrogen and a solid carbon product.

23. The process of claim 22, wherein the catalyst is in a fluidized bed.

24. The process of claim 22, wherein prior to reaction the catalyst is reduced by heating to a temperature in the range of from 400 to 700° C.

25. The process of claim 24, wherein the reducing is conducted at a temperature of about 600° C.

26. The process of claim 22, wherein catalyst is made with a support comprising carbon nanotubes and the solid carbon product comprises carbon nanotubes.

27. The method of claim 1, wherein the molar ratio of Ni to Cu in the mixture ranges from 1/1 to 100/1 nickel/copper, or 1/1 to 30/1 nickel/copper, or from 1/1 to 10/1 nickel to copper.

28. The method of claim 1, wherein the molar ratio of the nickel to chelating agent in the mixture ranges from 2/1 to 1/20 nickel/chelating agent, or from 1/1 to 1/10 nickel/chelating agent.
